(19) United States
(12) Patent Application Publication
(10) Pub. No.: US 2021/0277205 A1
(43) Pub. Date: Sep. 9, 2021

(54) Compatibility Quantification Of Binary Elastomer-Filler Blends

(71) Applicants: Bridgestone Corporation, Chuo-ku (JP); University of Cincinnati, Cincinnati, OH (US)

(72) Inventors: Yan Jin, Cincinnati, OH (US); Gregory Beaucage, Cincinnati, OH (US); Karsten Vogtt, Cincinnati, OH (US); Hanqiu Jiang, Cincinnati, OH (US); Vikram K. Kuppa, Cincinnati, OH (US); Hyeonjae Kim, Copley, OH (US); Jan Ilavsky, Argonne, IL (US); Mindaugas Rackaitis, Hudson, OH (US)

(21) Appl. No.: 17/150,465

(22) Filed: Jan. 15, 2021

Related U.S. Application Data
(63) Continuation of application No. 16/584,047, filed on Sep. 26, 2019, now abandoned.
Application No. 16/584,047 is a continuation of application No. 15/809,204, filed on Nov. 10, 2017, now abandoned.
(60) Provisional application No. 62/420,131, filed on Nov. 10, 2016.

(51) Int. Cl. C08K 3/36; G01N 15/08; C08K 3/04

(52) U.S. Cl. CPC C08K 3/36; G01N 2015/0866; C08K 3/04; G01N 15/08

(57) ABSTRACT

Compatibility in polymer compounds is determined by the kinetics of mixing and chemical affinity. Compounds like reinforcing filler/elastomer blends display some similarity to colloidal solutions in that the filler particles are close to randomly dispersed through processing. Applying a pseudo-thermodynamic approach takes advantage of this analogy between the kinetics of mixing for polymer compounds and true thermally driven dispersion for colloids. The results represent a new approach to understanding and predicting compatibility in polymer compounds based on a pseudo-thermodynamic approach.

### CROSS-REFERENCE TO RELATED APPLICATIONS

This application is a continuation of U.S. application Ser. No. 16/584,047, filed Sep. 26, 2019, which is a continuation of U.S. application Ser. No. 15/809,204, filed Nov. 10, 2017, which claims priority to U.S. Provisional Application No. 62/420,131, filed Nov. 10, 2016, all of which are incorporated by reference herein in their entirety.

### BACKGROUND

Processed polymers usually consist of multiple immiscible components such as pigments, fillers, and compounding agents. For complex polymeric mixtures an understanding of relative compatibility of components on a fundamental level is desirable. Such an understanding could help in the design of polymer compounds and in the control and prediction of behavior. For example, reinforcing fillers such as carbon black (CB) and silica are used in rubbers products. The reinforcing ability depends on the structure of the fillers, and the interaction between filler particles and the elastomer matrix. Aggregated fillers can be quantified by the specific surface area, the related primary particle size, the degree of graphitization for carbon, and the hydroxyl surface content for silica. A description of filler structure also includes the fractal aggregate structure that allows access to the surface through structural separation of primary particles. The fractal structure also contributes a static spring modulus to the composite at size scales larger than the filler mesh size for concentrations above the percolation threshold. Aggregates are often clustered in agglomerates that can be broken up during the elastomer milling process.

Fillers display different affinities for various polymers. This affinity is evidenced by their dispersability and their reinforcing properties in elastomer composites. Since fillers are often nanomaterials, standard characterizations of compatibility focus on the specific surface area. Surface area of fillers is usually measured by iodine adsorption (mg/g of filler), or nitrogen adsorption (m²/g of filler), or cetyltrimethylammonium bromide (CTAB) adsorption (m²/g of filler). The structure of fillers has been quantified using oil absorption (g/100 g of filler) or dibutyl phthalate (DBP) absorption (ml/100 g of filler) for CB, as well as through a variety of surface characterization techniques such as determination of the surface hydroxyl content for silica, and the degree of graphitization for carbon black. In addition, techniques have been applied to study compatibility of filler in the rubber matrix by investigating surface and aggregate structure. Atomic force microscopy (AFM) and small angle x-ray scattering (SAXS) have been used to study surface structure and fractal dimension of CB. Scanning electron microscopy (SEM) and transmission electron microscopy (TEM) were used to study particle size and morphology of aggregates.

### SUMMARY

A method of preparing a blended mixture, the method including mixing an elastomer and a filler to form a test blended mixture; measuring a second virial coefficient, A₂, of the test blended mixture; comparing the measured second virial coefficient of the test blended mixture to a threshold value for a production blended mixture; wherein if the measured second virial coefficient of the test blended mixture is higher than the threshold value for a production blended mixture, further preparing a final blended mixture by mixing additional elastomer and filler.

A method of preparing a blended mixture, the method including mixing an elastomer and a filler to form a blended mixture; measuring a second virial coefficient, A₂, of the blended mixture; comparing the measured second virial coefficient of the blended mixture to a reference second virial coefficient value for a combination of the elastomer and the filler; wherein if the measured second virial coefficient of the blended mixture is lower than the reference second virial coefficient, further mixing the blended mixture to form a dispersed blended mixture.

A method of preparing a blended mixture, the method including selecting an elastomer and filler from a reference elastomer/filler combination having a reference second virial coefficient, A₂, greater than 5 cm³/g²; mixing the elastomer and the filler to form a blended mixture; measuring a second virial coefficient, A₂, of the blended mixture; and optionally further mixing the blended mixture until the blended mixture has a measured second virial coefficient greater that the reference second virial coefficient.

### DRAWINGS

FIG. 1 is a schematic of the screening effect and scattering in the semi-dilute regime.

FIG. 2 is a schematic of formation of agglomerate superstructure in the concentrated regime from the third structure in FIG. 1. The top is fractal super structure and the bottom is domain super structure.

FIG. 3 shows plots of the three 1 wt. % carbon black 330 reinforced polymers. A two level unified fit to the NPB-CB330_1 samples is shown.

FIG. 4 is a log I/ϕ versus log q for NPB-CB330. A fit for the 1% sample is fit from 1 to 30% samples using one parameter. Intensity at intermediate-q drops with concentration following equation 8. Values of 1/(νϕ_{wt}) are also plotted for comparison with the scattering curve, ν=1.35×10⁻⁶ cm.

FIG. 5 is a comparison of ν for each polymer/filler mixture.

FIG. 6 is a comparison of A₂ for each polymer/filler mixture. The larger A₂ the more compatible the binary mixture. (Negative values, not seen here, indicate incompatibility.)

FIG. 7A is a sample displaying significant structural changes on milling of higher concentration blends.

FIG. 7B is a sample with little or no structural changes which is amenable to the pseudo-thermodynamic approach.

FIG. 8 is a plot of A₂ versus primary particle size (Sauter mean diameter).

FIG. 9. Calculation from equation (3) and (5) for B₂ based on the average end to end distance from Table 4. Horizontal lines show the experimentally measured values for B₂.

FIG. 10 is a plot of percolation concentration of CB and silica as a function of R_{g2}^{df-3}.

FIG. 11 is a plot of mesh size of the filler in three polymers as a function of filler concentration.

### DETAILED DESCRIPTION

Silica is the traditional reinforcing filler for polydimethylsiloxane elastomers due to compatibility in chemical structure. Silica was introduced as a reinforcing filler for diene elastomers for tires in the 1990's and showed a lower rolling resistance and higher fuel efficiency compared to carbon black reinforcing filler. However, silica is very different compared to CB due to its strong polar and hydrophilic surface. A certain quantity of moisture can be adsorbed on silica surface making it difficult to remove. Inter-particle interaction of silica due to hydrogen bonding needs to be considered since it reduces the compatibility of silica and rubber.

The compatibility of colloidal solutions such as mixtures of miscible polymers, solutions of low molecular weight organics and inorganics, and biomolecules is often quantified using a virial expansion to describe the concentration dependence of the osmotic pressure. This approach assumes that molecular and nanoscale motion is governed by thermally driven diffusion with a molecular energy of kT. Elastomer/reinforcing filler compounds have not been considered colloidal mixtures since the materials are highly viscous or solid networks, so thermally driven motion of reinforcing filler aggregates is not expected in an elastomer composite. However, the second virial expansion approach can be used in viscous systems such as in polymer melts where Flory-Huggins theory is applied, a form of the virial expansion for macromolecules. The virial coefficient is also used in native state protein solutions where rigid protein nanostructures are considered. The quantification of compatibility using a pseudo-virial approach may be of value in reinforced elastomer systems and potentially in a number of other similar systems where an analogy can be considered between randomly placed filler aggregates dispersed in the milling process and randomly placed molecules dispersed by thermal motion. In this analogy, it is assumed that the mixture has reached a terminal state of dispersion, or at least a relative state of dispersion when comparing different processing conditions and materials. In this pseudo-thermodynamic approach, processing time, accumulated strain, matrix viscosity all can have an equivalence to temperature in a true thermodynamic system.

In colloidal mixtures the miscibility of a binary system can be considered in terms of the second virial coefficient. For instance, protein precipitation from solution in the process of protein crystallization has been predicted using the second virial coefficient. The virial expansion is used to describe deviations from ideal osmotic pressure conditions, π=ϕₙᵤₘRT, to a power series expansion,

$$\frac{π}{k T} = {ϕ}_{num} + {B}_{2} {ϕ}_{num}^{2} + {B}_{3} {ϕ}_{num}^{3} + … \qquad ( 1 )$$

where ϕ is the number density of particles or molecules. B₂ indicates the enhancement of osmotic pressure due to binary interactions of a colloid in a matrix in terms of the thermal energy, kT. B₂ is related to an integral of the interaction energy between particles. Such a binary interaction energy can be used as an input to computer simulations of polymer/filler mixing. B₂ could also be used to quantify filler/polymer interactions in the prediction of mechanical and dynamical mechanical performance. If trends in B₂ can be determined as a function of chemical composition of an elastomer matrix or surface-active additives, then these values could be used to predict the performance of new compositions for enhanced performance. In this study a binary compound could be considered a polymer and miscible additives such as oil/plasticizer and processing aids, making up the matrix phase, mixed with an immiscible additive such as a reinforcing filler.

A parallel definition of the second virial coefficient using the mass density concentration, ϕₘₐₛₛ, rather than the number density concentration, ϕₙᵤₘ, is possible,

$$\frac{π}{R T} = {ϕ}_{mass} / M + {A}_{2} {ϕ}_{mass}^{2} + {A}_{3} {ϕ}_{mass}^{3} + … \qquad ( 2 )$$

where M is the molecular weight of a particle. ϕₘₐₛₛ=Mϕₙᵤₘ/Nₐ, where Nₐ is Avogadro's number, and A₂=B₂Nₐ/M², following Bonneté et al. B₂ is related to the binary interaction potential for particles, U(r), by,

$${B}_{2} = 2 π {\int }_{0}^{σ} {r}^{2} ( 1 - {e}^{- U ( r ) / kT} ) dr \qquad ( 3 )$$

B₂ has units of cm³/particle, and A₂ has units of mole cm³/g². If a hard core potential is assumed, then the hard core radius, σ_{HC}, is given by,

$${σ}_{HC} = {( \frac{3 {A}_{2} {M}^{2}}{2 π {N}_{a}} )}^{\frac{1}{3}} = {( \frac{3 {B}_{2}}{2 π} )}^{\frac{1}{3}} \qquad ( 4 )$$

σ_{HC} should be a size scale on the order of the size of an aggregate.

The second virial coefficient can be used to predict stability and compatibility of elastomer/filler systems, especially when coupled with DPD (dissipative particle dynamics) simulations. A typical repulsive potential for a DPD system is of the form,

$$\frac{U ( r )}{k T} = {\frac{A}{2} [ 1 - ( \frac{r}{σ} ) ]}^{2} \qquad ( 5 )$$

where σ is the diameter of the aggregates, here the end to end distance R_{eted} is used, and A is a dimensionless binary short range repulsive amplitude that can be defined for particle interactions. Equation (5) can be used in equation (3) and numerically solved for “A” using B₂. “A” could be used to simulate the behavior of a filler in an elastomer matrix to determine the segregation of filler in a polymer blend.

Scattering data from carbon black reinforced elastomer composites was fit using the unified scattering function with four structural levels. First a unified function for the mass fractal aggregates was used with three structural levels, equation 6,

$${I}_{0} ( q ) = {\sum }_{0}^{2} \{ {G}_{i} e ( {}^{- {q}^{2} {R}_{gi}^{2} / 3} ) + e ( {}^{- {q}^{2} {R}_{gi + 1}^{2} / 3} ) {B}_{i} q {{}^{*}}^{- {P}_{i}} \} \qquad ( 6 )$$

where level 0 pertains to a graphitic layer, level 1 to the primary particles and level 2 the aggregate structure. Level 0 does not exist for silica. The subscript “I₀” in equation (6) refers to dilute conditions or isolated fractal aggregates in the absence of screening. For each structural level the unified function uses four parameters to describe a Guinier and a power-law decay regime. For the smallest scale a graphitic layer, level 0, can be observed with a power-law decay of −2 slope for 2d graphitic layers, which can have a lateral dimension of about 15 Å. Level 1 pertains to the primary particles of the aggregates, which can have a radius of gyration of about 170 Å. The primary particles form aggregates, level 2, can have a mass fractal dimension of about 2.1, and the aggregates can have a radius of gyration of about 2,200 Å.

From the scattering fitting parameters several calculated parameters can be obtained. For the primary particles, the Sauter mean diameter, dₚ, and a polydispersity index, PDI, can be obtained and from these values the log-normal geometric standard deviation, σ_{g}, and the geometric mean value of size, μ can be determined. For the fractal portion of the scattering curve the minimum dimension, dₘᵢₙ, connectivity dimension, c, mole fraction branching, ϕ_{Br}, degree of aggregation, DOA, aggregate polydispersity, Cₚ, and average branch length, z_{Br}, can be obtained. The end to end distance, used for σ in equation 5, can be calculated from,

R_{eted}˜dₚp^{1/d}^{ₙᵤₘ} (7)

The interaction between filler and elastomer can be modeled using the random phase approximation, RPA,

$$\frac{{ϕ}_{w}}{I ( q )} = \frac{{ϕ}_{w}}{{I}_{0} ( q )} + υ {ϕ}_{w} \qquad ( 8 )$$

where ϕ_{w} is the weight fraction, and ν is related to the second virial coefficient by,

$${A}_{2} = ( \frac{υ 〈 Δ {ρ}^{2} 〉}{{N}_{a} {ρ}^{2}} ) \\ {B}_{2} = {M}^{2} {A}_{2} / {N}_{a} = {[ z {ρ}_{particle} ( 4 {π ( {d}_{p} / 2 )}^{3} / 3 ) ]}^{2} {A}_{2} / {N}_{a} \qquad ( 9 )$$

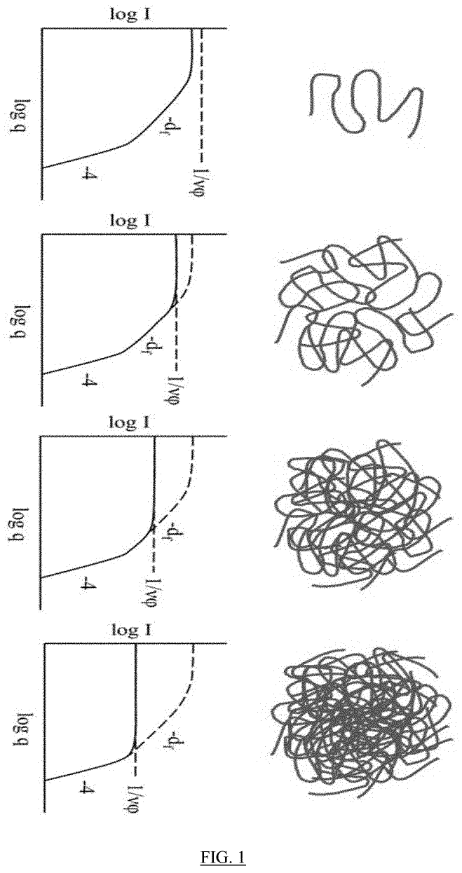

FIG. 1 is a schematic of the effect of νϕ_{w} in equations (6) to (9) on the scattering pattern as well as a drawing of how the overlap of aggregates (shown as a chain structure) can lead to the loss of resolution of an individual chain aggregate for concentrations above the overlap concentration. The mesh size, a size-scale where the structure of the first drawing can be resolved in the more concentrated samples becomes smaller with increasing concentration. This can be observed as the point where the horizontal line crosses the dilute I/φ curve. The local percolation threshold or overlap concentration is the concentration where the local concentration matches the concentration within an aggregate or chain structure. This is a concentration between the first two drawings in FIG. 1 and a point where the dashed horizontal line just meets the scattering curve.

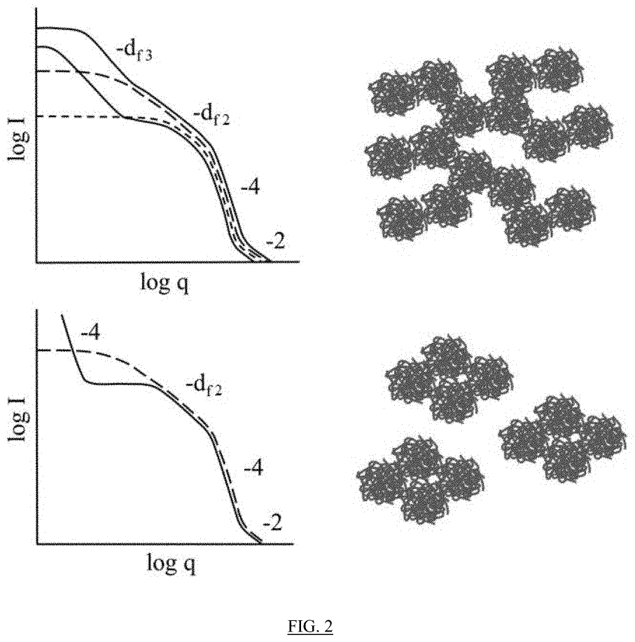

In addition to the mass fractal structure and screening (equations (6) and (8)), FIG. 2 shows the effect on scattering of the formation of a super-structure composed of fractal aggregates that agglomerate either into a mass fractal structure or into 3D-domains. For the carbon black the super-structure displays a fractal-like mass distribution, but only the power-law decay from these agglomerates of aggregates is observed with a fractal dimension of about 2.8. Equation (10) accommodates this agglomerate structure as a fourth structural level using the unified approach.

$${I}_{final} ( q ) = I ( q ) + e {(}^{- {q}^{2} {R}_{g 2}^{2} / 3} ) {B}_{3} {q}^{* - {P}_{3}} \qquad ( 10 )$$

where B₃ is the power-law prefactor for the lowest-q agglomerate structure. The agglomerate scattering is observed to be independent of the screening effect of equation 8.

### EXAMPLES

Samples were milled in a 50 g Brabender mixer at 130° C. with a rotor speed of 60 rpm for 6 min until the torque versus time curve had dropped from a peak value and reached a plateau. Table 1 shows the 15 sample types for three elastomers filled with five fillers. Each type was studied with four concentrations of 1, 5.6, 15.1 and 29.9 wt. %. PB2 was provided by Bridgestone Americas, while newPB and PI were obtained from Sigma Aldrich. CB110 and CB330 were from Continental Carbon and CRX2002 from Cabot. SiO₂190 was from PPG and SiO₂130 was from Evonik. Measurements were performed at the Advanced Photon Source, Argonne National Laboratory using the Ultra-Small-Angle X-ray Scattering (USAXS) facility located at the 9 ID beam line, station C.

TABLE 1
USAXS sample types (each with four concentrations
1, 5.6, 15.1, and 29.9 wt. %)

| | SiO₂ | SiO₂ | CB | CB | CRX |
|---|---|---|---|---|---|
| | 130 | 190 | 110 | 330 | 2002 |
| New | NPB- | NPB- | NPB- | NPB- | NPB- |
| PB | Si130 | Si190 | CB110 | CB330 | CRX |
| PI | PI-Si130 | PI-Si190 | PI-CB110 | PI-CB330 | PI-CRX |
| PB2 | PB2-Si130 | PB2-Si190 | PB2-CB110 | PB2-CB330 | PB2-CRX |

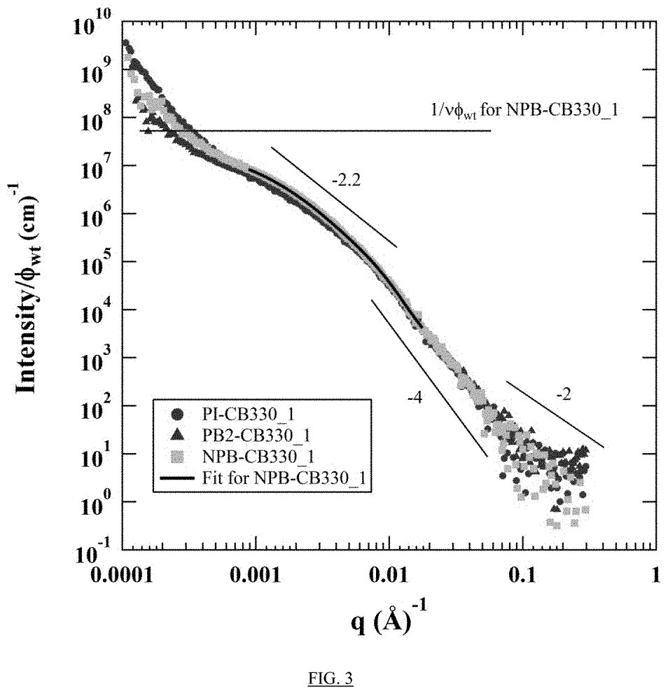

FIG. 3 shows plots of the three one percent CB samples, NPB-CB330_1, PI-CB330_1, PB2-CB330_1 and fit for NPB-CB330_1. The pure polymer scattering was subtracted from the composite samples and the resulting intensity was normalized by filler concentration. Tables 2 and 3 show the fit and calculated results for the 15 one percent samples listed in Table 1.

The scattering pattern at 1 wt. % reflects the structure of CB aggregates. The carbon black includes four levels of structure. Level 0 pertains to the graphitic structure observed above q=0.02 Å⁻¹. The graphitic level displays a power-law −2 for the 2d structure. From about 0.008 to 0.02 Å⁻¹ the primary particle structure is observed, level 1. This level displays smooth sharp surfaces and a power-law decay of −4 slope following Porod's law. From 0.0008 to 0.008 Å⁻¹ the fractal aggregate, level 2, is observed with a power-law decay reflecting −d_{f} for the aggregate. At the lowest q, steep power-law decay is observed reflects surface scattering from a large-scale structure of agglomerates of CB aggregates or from defects in the samples. The power-law decay varies between mass fractal and domain structures. Only scattering from the dispersed aggregates component of the structure is considered for the determination of A₂. Screening in equation (8) only effects levels 0 to 2 since the large-scale super-structure, level 3, is under dilute conditions. At higher concentrations fits to only levels 1 to 2 are considered since the graphitic structure of CB does not change.

FIG. 3 shows that for the dilute 1% filled samples, a given filler displays the same q dependence regardless of matrix polymer. Differences in absolute intensity due to differences in contrast are observed, which indicates that structure change is minimal at the nano-scale when milled with different polymers.

TABLE 2
Structural fit parameters for the dilute 1% carbon black and silica samples.

| | G₁, cm⁻¹ | R_{g1}, Å | B₁, cm⁻¹ Å^{-P1} | P₁ | G₂, cm⁻¹ | R_{g2}, Å | B₂, cm⁻¹Å^{-P2} | P₂ |
|---|---|---|---|---|---|---|---|---|
| NPB-Si130_1 | 210000 | 256 | 0.0015 | 4 | 13000000 | 1180 | 0.258 | 2.6 |
| PI-Si130_1 | 260000 | 280 | 0.00117 | 4 | 22200000 | 1180 | 0.628 | 2.6 |
| PB2-Si130_1 | 253000 | 257 | 0.0019 | 4 | 17000000 | 1180 | 0.521 | 2.58 |
| NPB-Si190_1 | 18400 | 86.1 | 0.00114 | 4 | 13200000 | 1300 | 0.251 | 2.52 |
| PI-Si190_1 | 14400 | 86.7 | 0.000732 | 4 | 13200000 | 1200 | 0.14 | 2.68 |
| PB2-Si190_1 | 17800 | 86 | 0.00202 | 4 | 8270000 | 1060 | 0.17 | 2.61 |
| NPB-CB110_1 | 302000 | 313 | 0.00046 | 4 | 6650000 | 1513 | 1.31 | 2.27 |
| PI-CB110_1 | 235000 | 293 | 0.000425 | 4 | 4500000 | 1420 | 0.631 | 2.35 |
| PB2-CB110_1 | 275000 | 298 | 0.000456 | 4 | 4050000 | 1380 | 0.784 | 2.32 |
| NPB-CB330_1 | 17193 | 163 | 0.000282 | 4 | 12500000 | 1750 | 3.56 | 2.15 |
| PI-CB330_1 | 25600 | 190 | 0.000128 | 4 | 15800000 | 2160 | 13.7 | 1.9 |
| PB2-CB330_1 | 17193 | 163 | 0.000282 | 4 | 12500000 | 1750 | 3.56 | 2.15 |
| NPB-CRX_1 | 18200 | 179 | 0.00048 | 4 | 10200000 | 1650 | 2.06 | 2.2 |
| PI-CRX_1 | 17000 | 179 | 0.0005 | 4 | 20500000 | 2880 | 8.04 | 2 |
| PB2-CRX_1 | 20900 | 179 | 0.0001 | 4 | 21000000 | 2880 | 7.2 | 2 |

TABLE 3
Calculated structural parameters for the dilute filler samples from the
first and second structural levels (primary particles and aggregates).

| | | | | | | | R_{eted}, | dₚ, | | | μ, |
|---|---|---|---|---|---|---|---|---|---|---|---|
| | z | dₘᵢₙ | c | d_{f} | Cₚ | p | nm | nm | PDI | σ_{g} | nm |
| NPB-Si130_1 | 61.9 | 1.40 | 1.86 | 2.60 | 1.53 | 9.2 | 92.9 | 19.0 | 19.4 | 1.64 | 133 |
| PI-Si130_1 | 85.4 | 1.85 | 1.41 | 2.60 | 1.65 | 23.7 | 118 | 21.3 | 17.1 | 1.63 | 155 |
| PB2-Si130_1 | 67.2 | 1.80 | 1.43 | 2.58 | 1.60 | 18.8 | 96.6 | 18.9 | 20.0 | 1.65 | 131 |
| NPB-Si190_1 | 717 | 1.28 | 1.96 | 2.52 | 1.15 | 28.2 | 221 | 16.3 | 2.11 | 1.28 | 149 |
| PI-Si190_1 | 917 | 1.41 | 1.90 | 2.68 | 1.50 | 36.2 | 236 | 18.5 | 1.77 | 1.24 | 164 |
| PB2-Si190_1 | 465 | 1.35 | 1.93 | 2.61 | 1.30 | 24.0 | 119 | 11.3 | 3.84 | 1.40 | 107 |
| NPB-CB110_1 | 22.0 | 1.96 | 1.16 | 2.27 | 1.80 | 14.4 | 110 | 28.3 | 9.00 | 1.53 | 245 |
| PI-CB110_1 | 19.2 | 1.98 | 1.19 | 2.35 | 1.98 | 12.1 | 96.0 | 27.3 | 8.27 | 1.52 | 241 |
| PB2-CB110_1 | 14.7 | 1.99 | 1.16 | 2.32 | 1.98 | 10.0 | 89.2 | 28.0 | 8.07 | 1.52 | 248 |
| NPB-CB330_1 | 324 | 1.83 | 1.21 | 2.20 | 1.60 | 123 | 253 | 18.3 | 8.37 | 1.52 | 162 |
| PI-CB330_1 | 617 | 1.18 | 1.61 | 1.90 | 1.50 | 54.1 | 715 | 24.3 | 4.02 | 1.41 | 231 |
| PB2-CB330_1 | 727 | 1.69 | 1.27 | 2.15 | 1.60 | 178 | 343 | 16.0 | 7.16 | 1.50 | 145 |
| NPB-CRX_1 | 560 | 1.53 | 1.43 | 2.20 | 1.60 | 81.5 | 243 | 13.7 | 16.6 | 1.62 | 101 |
| PI-CRX_1 | 1210 | 1.86 | 1.08 | 2.00 | 1.75 | 736 | 466 | 13.4 | 18.6 | 1.64 | 94.8 |
| PB2-CRX_1 | 1010 | 1.77 | 1.13 | 2.00 | 1.60 | 456 | 852 | 26.8 | 3.03 | 1.35 | 253 |

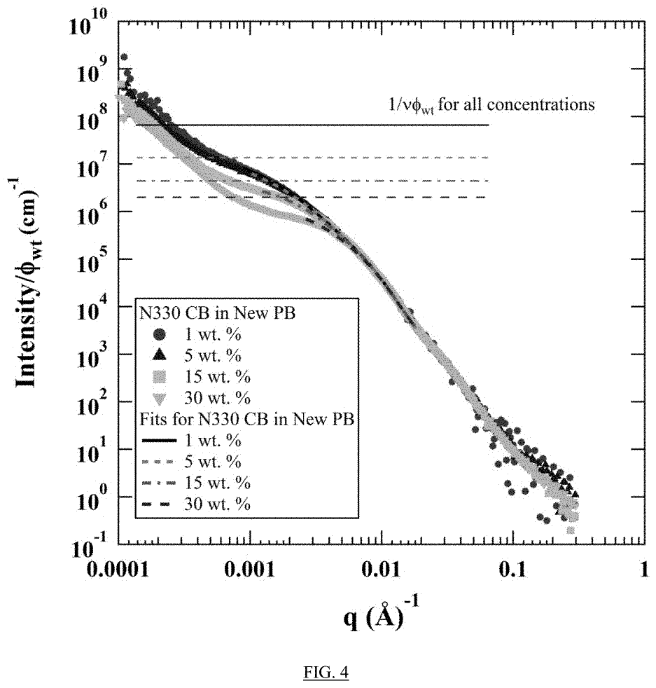

FIG. 4 shows scattering from the concentration series for the NPB-CB330 samples. As concentration increase, the high-q part of the concentration reduced scattering curves remains unchanged in a log-log plot of I/ϕ_{wt} versus q. At intermediate-q the intensity drops due to the screening effect of equation (8). The rate of decrease in the intensity with concentration is an indicator of filler dispersion in the elastomer. For example, if the filler were in a thermodynamically equilibrated colloidal dispersion, this diminution of 1/ϕ_{wt} would be related to either the second virial coefficient or the excluded volume and χ-parameter for polymer blends. For filler in an elastomer, thermodynamic mixing governed by k_{B}T does not exist. Instead, there is a random dispersion caused by mechanical milling. For this case, a processing relationship is expected to the pseudo-thermodynamic property that we observe in the reduction in I/ϕ_{wt} with concentration for filled elastomers.

To obtain values for ν in FIG. 4, fits were performed on the lowest concentration samples, NPB-CB330_1 setting νϕ_{wt} in equation (8) to 0. Under the assumption that the carbon black structure is not sensitive to concentration, fits using the structural parameters from the 1% sample, listed in Table 2, were done for each concentration sample, NPB-CB330_5, NPB-CB330_15, and NPB-CB330_30, fitting only ν. Then calculated curves for the 5%, 15% and 30% were compared with the measured intensity. Verification that νϕ_{wt} do not impact the scattered intensity is observed when the value of 1/(νϕ_{wt}) is far larger than the scattered intensity for the fractal part of the dilute curve as seen in FIG. 3 for the 1% samples. FIG. 4 shows the impact of νϕ_{wt} for the entire concentration series for NPB.

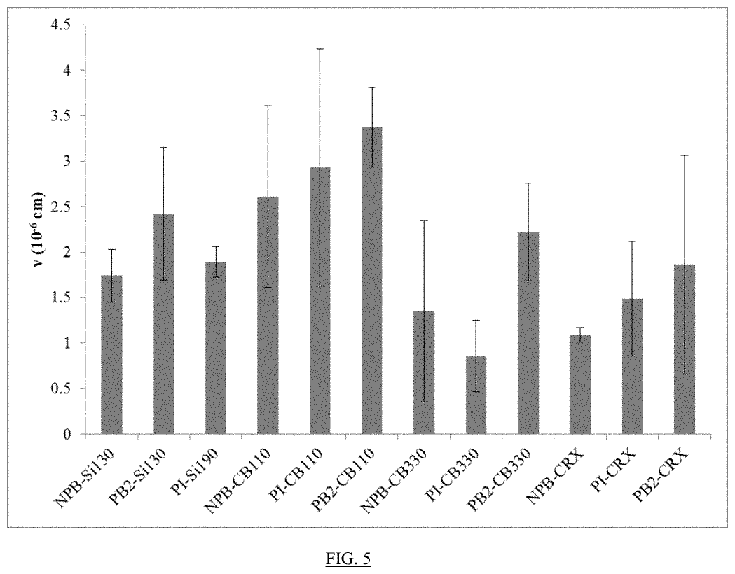

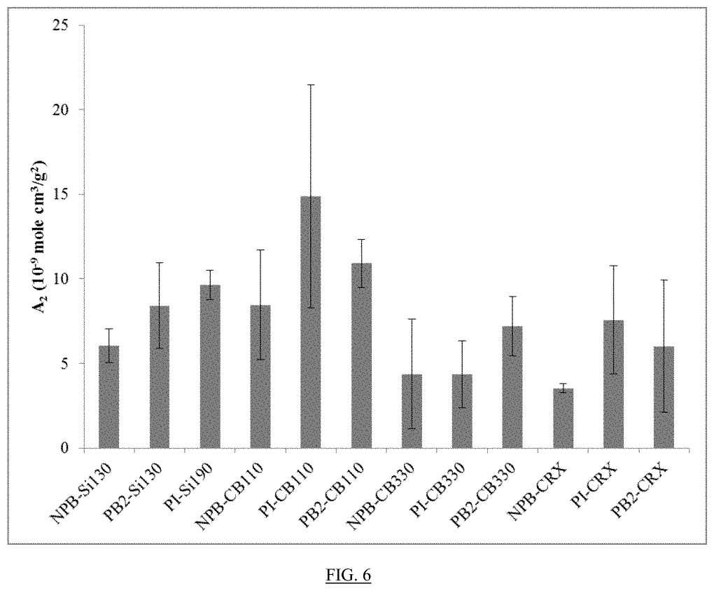

The pseudo-second order virial coefficient, A₂, in binary milled compounds is obtained from the rate of dampening of the mid-q data in FIG. 4. The larger A₂, the greater the rate of dampening in concentration and the better dispersed, or more compatible the filler/elastomer/compounding agent mixture. Table 4 and FIGS. 5-6 show the values of ν from equation 8 and the calculated A₂ for the three polymer composites. A₂ is converted to B₂ using the mean value of dₚ, Table 4. The hard-core diameter, σ_{HC}, is calculated from B₂, Table 4. Finally, equations 5 and 3 are used to determine the short range potential amplitude “A” using the mean value of the chain end-to-end distance, R_{eted}=<dₚ>p^{1/dmin}, for σ.

TABLE 4
Values of v and A₂ from equations 8 and 9. B₂ calculated from
A₂, σ_{HC} from equation 4, and “A” from equation 3 and
5 using σ = <R_{eted}> from Table 3. (SC = Structural Changes)

| | v, | A₂, | B₂, | | |
|---|---|---|---|---|---|
| | 10⁻⁶ | 10⁻⁹ mole | 10⁻¹⁴ | σ_{HC}, | A |
| | cm | cm³/g² | cm³/Aggregate | nm | (Eqn. 5) |
| NPB-Si130 | 1.7 ± 0.3 | 6 ± 1 | 0.09 | 75.5 | 38.9 |
| PI-Si130 | SC | | | | |
| PB2-Si130 | 2.4 ± 0.7 | 8 ± 3 | 0.14 | 87.8 | 164 |
| NPB-Si190 | SC | | | | |
| PI-Si190 | 1.9 ± 0.2 | 9.6 ± 0.9 | 25.8 | 503 | — |
| PB2-Si190 | SC | | | | |
| NPB-CB110 | 3 ± 1 | 8 ± 3 | 0.13 | 85.2 | 26.2 |
| PI-CB110 | 3 ± 1 | 15 ± 7 | 0.13 | 86.8 | 118 |
| PB2-CB110 | 3.4 ± 0.4 | 11 ± 1 | 0.07 | 70.4 | 26.9 |
| NPB-CB330 | 1 ± 1 | 4 ± 3 | 1.03 | 172 | 10.7 |
| PI-CB330 | 0.9 ± 0.4 | 4 ± 2 | 20.2 | 464 | 8.46 |
| PB2-CB330 | 2.2 ± 0.5 | 7 ± 2 | 3.79 | 265 | 23.7 |
| NPB-CRX | 1.09 ± 0.08 | 3.5 ± 0.3 | 0.44 | 129 | 3.71 |
| PI-CRX | 1.5 ± 0.6 | 8 ± 3 | 3.82 | 266 | 4.86 |
| PB2-CRX | 2 ± 1 | 6 ± 4 | 135 | 873 | — |

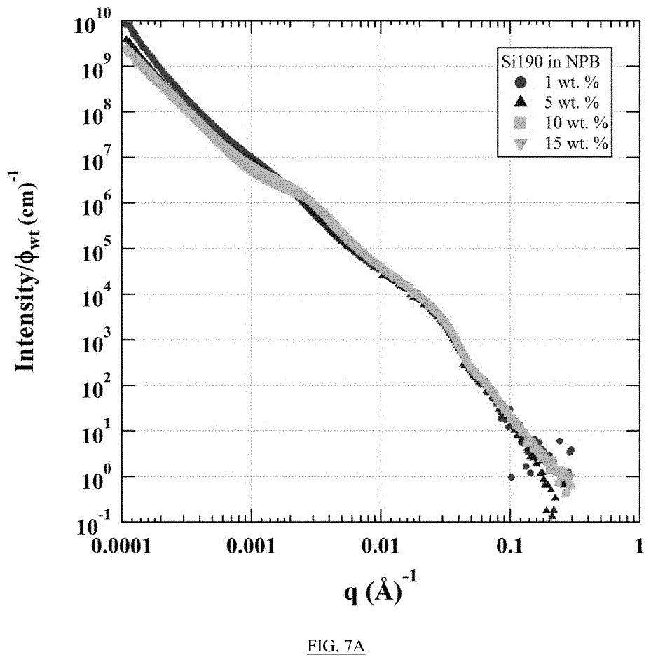

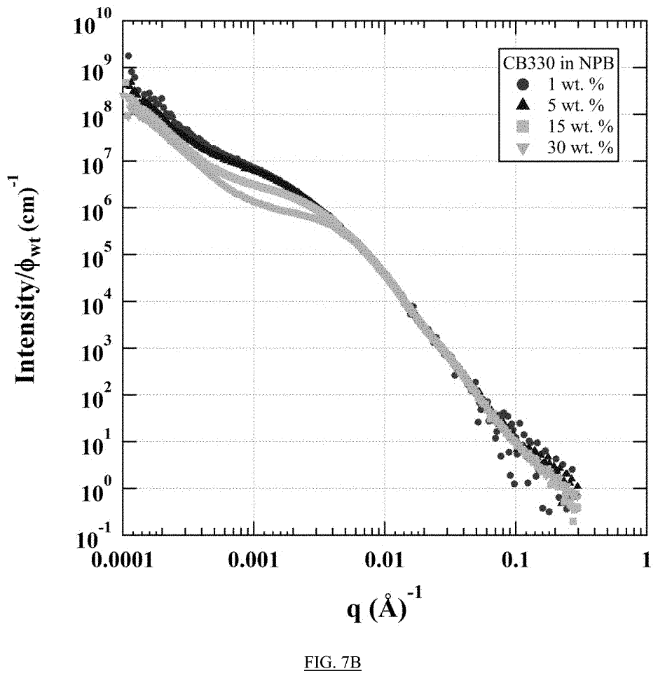

Samples are marked as “SC” in Table 4 and 5 indicating an aggregate structural change at higher concentrations. FIG. 7 shows an example where the fractal aggregate of Si190 in 2^{nd} level has a structural change for higher concentration blends in new PB, while CB330 does not show a structural change in new PB. Structural change may be caused by the breakage of filler aggregates during milling at high filler concentrations.

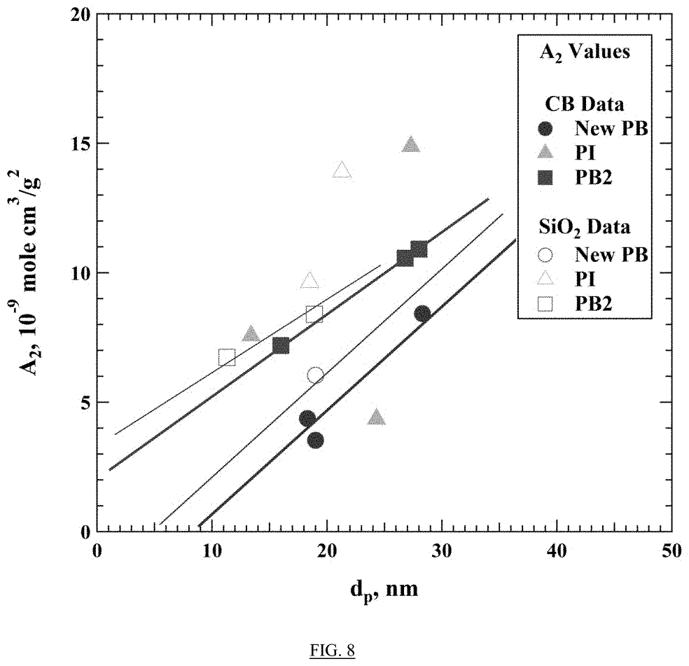

The second virial coefficient is an indication of miscibility with larger values indicating greater affinity in a binary mixture. It is observed that mixing of finer particulate fillers is more difficult than coarser fillers. FIG. 8 shows close to a linear relation between A₂ and the primary particle Sauter mean diameter, dₚ, for various nanoparticulate fillers, which suggests that smaller nanoparticles display lower compatibility. The symbols are grouped into polymer type, circles NPB, squares PB2, and triangles PI. The open symbols are for silica fillers and the closed symbols carbon black. It is seen that silica displays a higher A₂ value indicating higher compatibility under the same mixing conditions and for the same primary particle size.

Of the three types of polymers PI, triangles in FIG. 8, displays consistently higher compatibility with the fillers. PB2 is more compatible compared with NPB. NPB has a higher cis content compared with PB2. It has been found that higher cis content reduces compatibility with carbon black, consistent with the observed behavior for A₂. Further, the intercept of the trend lines in FIG. 8 at dₚ=0 reflects the A₂ value for a particle completely composed of surface, S/V=∞. This intercept is positive and large for PI, positive for PB2, and negative for NPB indicating surface attributes that encourage mixing in PI and PB2, but which encourage demixing for NPB.

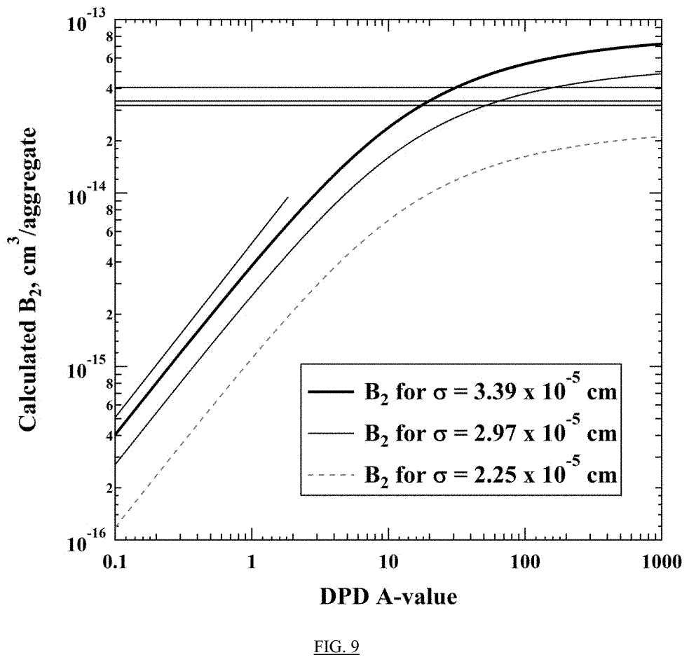

FIG. 9 demonstrates the graphical determination of the short range potential amplitude “A” from equation 5 using the measured B₂ value and R_{eted}. In FIG. 9, the horizontal lines are the experimentally measured B₂ values shown in Table 4. The intersection of the horizontal line and the calculated curve provides the graphically determined value for “A” which can be further used to define the short range interaction potential in equation 5. This potential is compatible with DPD simulations. For two samples, PI-Si190 and PB2-CRX, the measured B₂ value was above the calculated curve so that an intersection did not exist.

The concentration series shown in FIG. 4 can be used to determine the overlap concentration for the aggregates, which is a type of local aggregate percolation threshold. The overlap concentration is the lowest value of concentration where 1/(vc) will impact the dilute I(q)/c curve for the aggregate structural level. The c value where 1/(vc)=G₂ from Table 2. Table 5 lists percolation concentrations of CB and silica in three polymers calculated in this way.

The percolation concentration of carbon black filled samples is usually measured by bulk conductivity, for example, it can be observed at concentrations in the range of 25 to 30 weight percent. Conductivity measurement quantifies the first point where a conductive pathway exists across millimeters of sample. The scattering overlap concentration reflects local percolation of the structure. Micrographs of the filled samples in Figures show such local percolation.

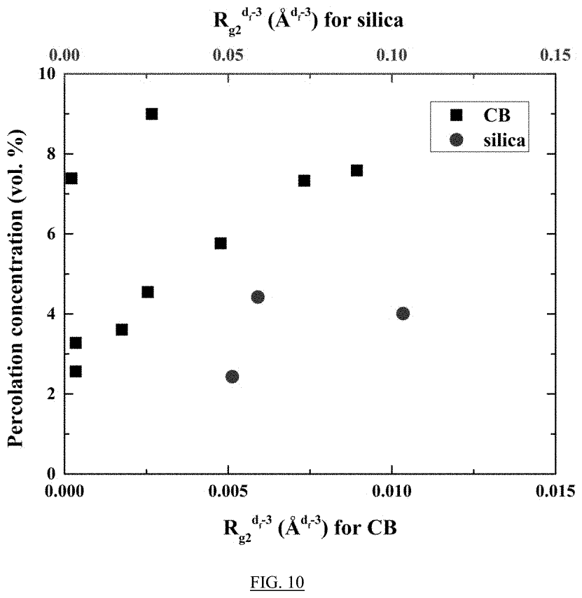

The percolation concentration follows the fractal scaling law so that c*˜M/V=R_{g2}^{df}/(R_{g2}³)˜R_{g2}^{df-3}. FIG. 10 shows a plot of the percolation concentration versus R_{g2}^{df-3} for CB and silica samples. In addition to the outlier points in FIG. 10, the linear intercept for the CB samples does not pass through (0, 0).

TABLE 5
Percolation concentrations of CB and silica in different
polymers. α value is power law parameter between
mesh size and filler concentration. (SC = Structural Changes)

| | vol. % at | wt. % at | |
|---|---|---|---|
| | percolation | percolation | α (log(mesh |
| | using G2 | using G2 | size)~α*log(c)) |
| NPB-Si130 | 4.4 | 10.14 | −0.67 |
| PI-Si130 | SC | SC | SC |
| PB2-Si130 | 2.4 | 5.73 | −0.71 |
| NPB-Si190 | SC | SC | SC |
| PI-Si190 | 4.0 | 9.25 | −0.49 |
| PB2-Si190 | SC | SC | SC |
| NPB-CB110 | 5.8 | 11.43 | −0.73 |
| PI-CB110 | 7.6 | 14.77 | −0.49 |
| PB2-CB110 | 7.3 | 14.30 | −0.69 |
| NPB-CB330 | 4.5 | 9.13 | −0.62 |
| PI-CB330 | 7.4 | 14.41 | −0.48 |
| PB2-CB330 | 3.6 | 7.31 | 0.69 |
| NPB-CRX | 9.0 | 17.26 | −0.54 |
| PI-CRX | 3.3 | 6.67 | −0.67 |
| PB2-CRX | 2.6 | 5.26 | −0.71 |

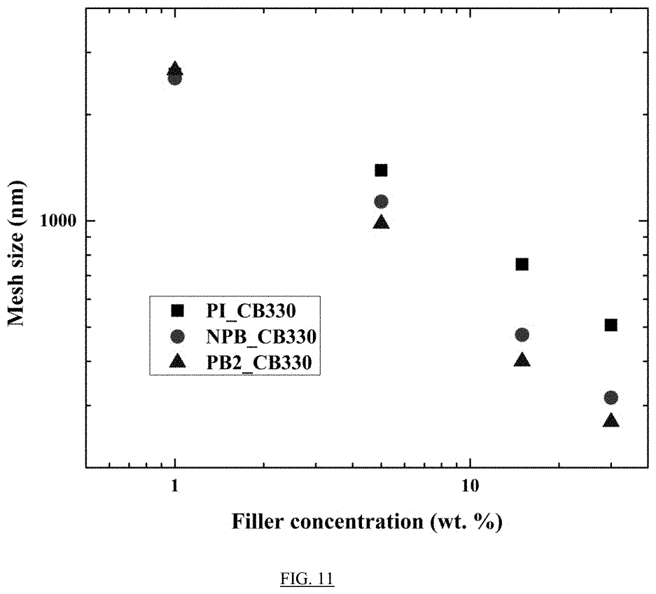

For filled elastomers with filler loading above the overlap concentration (percolation threshold) the filler particles form a network with a mesh size that decreases with increasing concentration, as shown in the drawings in FIG. 1. For size scales larger than the mesh size (reflecting large relaxation times) the elastomer properties should be dominated by the filler network, while for size scales smaller than the mesh size (and short relaxation times) the properties are dominated by the elastomer. For this reason the filler network mesh size is quantified. The mesh size of the filler network above the percolation threshold concentration is given by 2π/q*, where q* is the q value when 1/(vc) equals I/c from the one weight percent scattering curve under dilute conditions. The mesh size decreases with concentration. FIG. 11 shows the mesh sizes calculated in this way for CB330 in different polymers as a function of filler concentration. CB330 shows a similar mesh size at low concentration in different polymers. The mesh size in PI shows a larger value than PBs at higher concentration with the difference increasing with concentration. This is consistent with percolation result that CB330 shows a lower percolation concentration in PBs than in PI, as well as the relative compatibility as indicated by A₂ values. The mesh size calculated in this way has a power-law relationship with filler concentration, linear regime at high concentration in the log-log plot of FIG. 11. The power-law slopes, α, are listed in the Table 5.

Immiscible mixtures of nano to colloidal particles in polymers show some resemblance to colloidal solutions. While colloidal solutions have a random dispersion of particles driven by dynamic thermal equilibrium and are influenced by enthalpic interactions between particles, polymer mixtures display a random dispersion of particles driven by the mixing process and influenced by surface interactions between particles. The effectiveness of mixing will depend on particle size, accumulated strain, viscosity of the matrix polymer and the hydrodynamic properties of the nanoparticles being dispersed. A pseudo-thermodynamic approach to these systems can be used to quantify the compatibility of a given nanoparticle and polymer binary pair. This approach can be used to rate different polymer/nanoparticle pairs as to relative compatibility. Reinforced elastomer composites were examined using this new application of the second virial coefficient to describe compatibility of carbon black and silica with three different elastomers. It was found that this approach distinguishes compatibility for different elastomer/filler compounds. Ultra small-angle x-ray scattering was used to measure the scattering pattern at several concentrations of filler. Changes in scattering with concentration were described with a single second virial coefficient for each elastomer using a scattering function related to the random phase approximation. The approach can be applicable to a wide range of nano composite materials.

The pseudo-second virial coefficient, A₂, was well behaved in the PB/PI and CB/SiO₂ compounds that were studied. A close to linear dependence of A₂ with primary particle size agrees well with the observation that it is more difficult to mix smaller particles. The interfacial contribution to this compatibility could be ascertained by the sign and value of the dₚ=0 intercept.

Values for the repulsive interaction potential amplitude, “A” were estimated for the samples from the A₂ values and calculations of R_{eted}. These values could be used in coarse grain computer simulations of filler segregation in these elastomers. The percolation threshold concentration and the mesh size for concentrations above overlap were determined. Both of these features are well behaved in the samples studied.

The present disclosure is a novel description of compatibility in polymer compounds that is useful in predicting compatibility in complex mixed systems, for example, systems based on processing history and tabulated values for A₂. The approach is versatile and can be applied to pigment dispersions and many other polymer/nanoparticle compounds.

1. A method of preparing a blended mixture, the method comprising:
mixing an elastomer and a filler to form a test blended mixture;
measuring a second virial coefficient, A₂, of the test blended mixture, wherein A₂ is measured by the equation,
$${A}_{2} = ( \frac{υ 〈 Δ {ρ}^{2} 〉}{{N}_{a} {ρ}^{2}} ) ;$$
comparing the measured second virial coefficient of the test blended mixture to a threshold value for a production blended mixture;
wherein if the measured second virial coefficient of the test blended mixture is higher than the threshold value for a production blended mixture, further preparing a final blended mixture by mixing additional elastomer and filler.

2. The method of claim 1, wherein the filler of the tested blended mixture is a reinforcing filler.

3. The method of claim 1, wherein the test blended mixture comprises the filler in an amount from 1 to 30 weight percent.

4. The method of claim 1, wherein the filler of the tested blended mixture is selected from the group consisting of carbon black, silica, and a combination thereof.

5. The method of claim 1, wherein the filler of the tested blended mixture is an aggregated filler.

6. The method of claim 1, wherein the filler of the tested blended mixture is a nanomaterial.

7. The method of claim 1, wherein the elastomer of the tested blended mixture is a diene elastomer.

8. The method of claim 1, wherein the final blended mixture is incorporated in a tire component.

9. A method of preparing a blended mixture, the method comprising:
mixing an elastomer and a filler to form a blended mixture;
measuring a second virial coefficient, A₂, of the blended mixture, wherein A₂ is measured by the equation,
$${A}_{2} = ( \frac{υ 〈 Δ {ρ}^{2} 〉}{{N}_{a} {ρ}^{2}} ) ;$$
comparing the measured second virial coefficient of the blended mixture to a reference second virial coefficient value for a combination of the elastomer and the filler;
wherein if the measured second virial coefficient of the blended mixture is lower than the reference second virial coefficient, further mixing the blended mixture to form a dispersed blended mixture.

10. The method of claim 9, wherein the filler of the blended mixture is selected from the group consisting of carbon black, silica, and a combination thereof.

11. The method of claim 9, wherein the blended mixture comprises the filler in an amount from 1 to 30 weight percent.

12. The method of claim 9, wherein the filler of the blended mixture is a nanomaterial.

13. The method of claim 9, wherein the filler of the blended mixture is an aggregated filler.

14. The method of claim 9, wherein the elastomer of the blended mixture is a diene elastomer.

15. A method of preparing a blended mixture, the method comprising:
selecting an elastomer and filler from a reference elastomer/filler combination having a reference second virial coefficient, A₂, greater than 5 cm³/g²;
mixing the elastomer and the filler to form a blended mixture;
measuring a second virial coefficient, A₂, of the blended mixture, wherein A₂ is measured by the equation, and
$${A}_{2} = ( \frac{υ 〈 Δ {ρ}^{2} 〉}{{N}_{a} {ρ}^{2}} ) ;$$
optionally further mixing the blended mixture until the blended mixture has a measured second virial coefficient greater that the reference second virial coefficient.

16. The method of claim 15, wherein the filler of the blended mixture is selected from the group consisting of carbon black, silica, and a combination thereof.

17. The method of claim 15, wherein the blended mixture comprises the filler in an amount from 1 to 30 weight percent.

18. The method of claim 15, wherein the filler of the blended mixture is a nanomaterial.

19. The method of claim 15, wherein the filler of the blended mixture is an aggregated filler.

20. The method of claim 15, wherein the elastomer of the blended mixture is a diene elastomer.
